(19) United States
(12) Patent Application Publication
(10) Pub. No.: US 2025/0113221 A1
(43) Pub. Date: Apr. 3, 2025

(54) BLOCKING MALFUNCTIONING NETWORK FUNCTIONS IN A CELLULAR TELECOMMUNICATIONS NETWORK

(71) Applicant: DISH Wireless L.L.C., Englewood, CO (US)

(72) Inventors: Abhishek Jayprakash Shirke, Aurora, CO (US); Dawood Shahdad, Aurora, CO (US); Prakash Patel, Castle Rock, CO (US); MythriAmulya Sabhapati, Highlands Ranch, CO (US)

(21) Appl. No.: 18/375,354

(22) Filed: Sep. 29, 2023

(51) Int. Cl. H04W 24/04; G06F 9/54; H04L 41/0659; H04L 41/16

(52) U.S. Cl. CPC H04W 24/04; G06F 9/547; H04L 41/0659; H04L 41/16

(57) ABSTRACT

According to various embodiments, the systems and methods disclosed herein can utilize a blocking service to prevent malfunctioning NF instances from being discovered by consumer NF instances in discovery requests within a wireless network (e.g., a 5G network). The blocking service can be integrated into an NRF of the wireless network and can be used to add a malfunctioning NF instance to a block list. Additionally, the blocking service can prevent any malfunctioning NF instance on the block list from being returned to a consumer NF instance during a discovery request. When an NF producer instance is determined to be malfunctioning and subsequently added to the block list, the blocking service can trigger a notification to be sent to an NF consumer instance that is utilizing the affected NF producer instance. Upon receipt of this notification, the NF producer instance can cease its consumption of the malfunctioning producer NF instance.

### TECHNICAL FIELD

The present disclosure relates generally to cellular telecommunications networks and, more particularly, to blocking malfunctioning network functions from being discovered in a wireless network.

### BRIEF SUMMARY

A fifth generation (5G) core network includes many network functions (NFs), such as mobility management function (AMF) and a session management function (SMF), and each NF can have multiple instances instantiated and running in the 5G network. NF instances can be registered with a network repository function (NRF) such that any NF instance that needs the services of another NF instance can request the services of the other NF through a discovery request sent to the NRF. Currently, when a particular NF instance malfunctions, that malfunctioning NF instance may still be discoverable through the NRF and receive service requests. The use of a malfunctioning NF instance, however, may have undesired consequences, such as failed services for Call, Data, etc. or leading to inaccurate billing. The malfunctioning NF instance can be manually scaled down or its routes to the NRF can be removed such that it stops sending heartbeat to the NRF and therefore is not discoverable. However, this approach to solving the problem can be time-consuming as it requires performing manual actions on the problematic node/NF instance and may often take longer than appropriate when recovery is critical to the operation of the 5G network. Further, each NF design/architecture being different complicates the manual effort to block the problematic NF.

According to various embodiments, the systems and methods disclosed herein can utilize a blocking service to prevent malfunctioning NF instances from being discovered by consumer NF instances in discovery requests within a 5G network. The blocking service can be integrated into an NRF of the 5G network and can be used to add a malfunctioning NF instance to a block list. Additionally, the blocking service can prevent any malfunctioning NF instance on the block list from being returned to a consumer NF instance during a discovery request. When an NF producer instance is determined to be malfunctioning and subsequently added to the block list, the blocking service can trigger a notification to be sent to an NF consumer instance that has subscribed for notifications services of the affected NF producer instance. Upon receipt of this notification, the NF consumer instance can cease its consumption of the malfunctioning producer NF instance. The embodiments described herein can effectively address malfunctions in NF instances more rapidly and efficiently in a centralized way as compared to the traditional approach, which involves manual removal of malfunctioning NF instances from the 5G network.

In an embodiment, a method of preventing malfunctioning producer NF instances from being discovered include receiving, at a network repository function (NRF) in the 5G network, a discovery request for one or more instances of a producer NF type from a consumer NF instance, wherein the NRF has a plurality of instances of the producer NF type registered with the NRF and at least one instance of the producer NF type is on a block list. The method further includes identifying a first list of instances of the producer NF type that each match the discovery request; and determining at least one instance of the first list of instances of the producer NF type is on the block list. The method further includes removing the at least one instance from the first list of instances of the producer NF to generate a second list of instances of the producer NF type; and responding to the consumer NF instance with the second list of instances of the producer NF.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1A is a block diagram illustrating how an NRF in a 5G network architecture facilitates communication among NF instances according to an embodiment of the disclosure.

FIGS. 1B, 1C and 1D are block diagram illustrating different models for NF/NF services interactions according to an embodiment of the disclosure.

FIG. 2 is a block diagram illustrating the NRF with an NF blocking service that can block a malfunctioning NF instance from being discovered according to an embodiment of the disclosure.

FIG. 3 is a block diagram illustrating a communication blocking function in each NF instance registered with the NRF 107 according to an embodiment of the disclosure.

FIG. 4 is a block diagram illustrating a system for automatically detecting malfunctioning NF instances in a 5G network and adds the malfunctioning instance to the block list according to an embodiment of the disclosure.

FIG. 5 illustrates an example of a multi-site 5G replication architecture where a block list created for a detected malfunctioning NF instance at of the sites can be replicated to all the other sites according to an embodiment of the disclosure.

FIG. 6 is a flow diagram illustrating a process of implementing a method of blocking malfunctioning producer NF instances from being discovered by consumer NF instances according to an embodiment of the disclosure.

FIG. 7 is a flow diagram illustrating a process showing impact of NF instance blocking on a consumer NF instance according to an embodiment of the disclosure.

FIG. 8 is a flow diagram illustrating a process of blocking a malfunctioning producer NF instance from being discovery by a consumer NF instance in a discovery request according to an embodiment of the disclosure.

FIG. 9 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments can be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments can be methods, systems, media, or devices. Accordingly, the various embodiments can be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

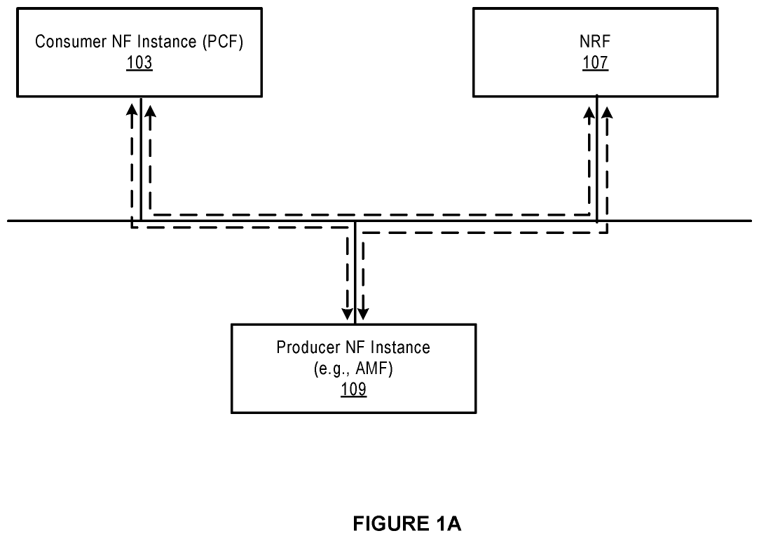

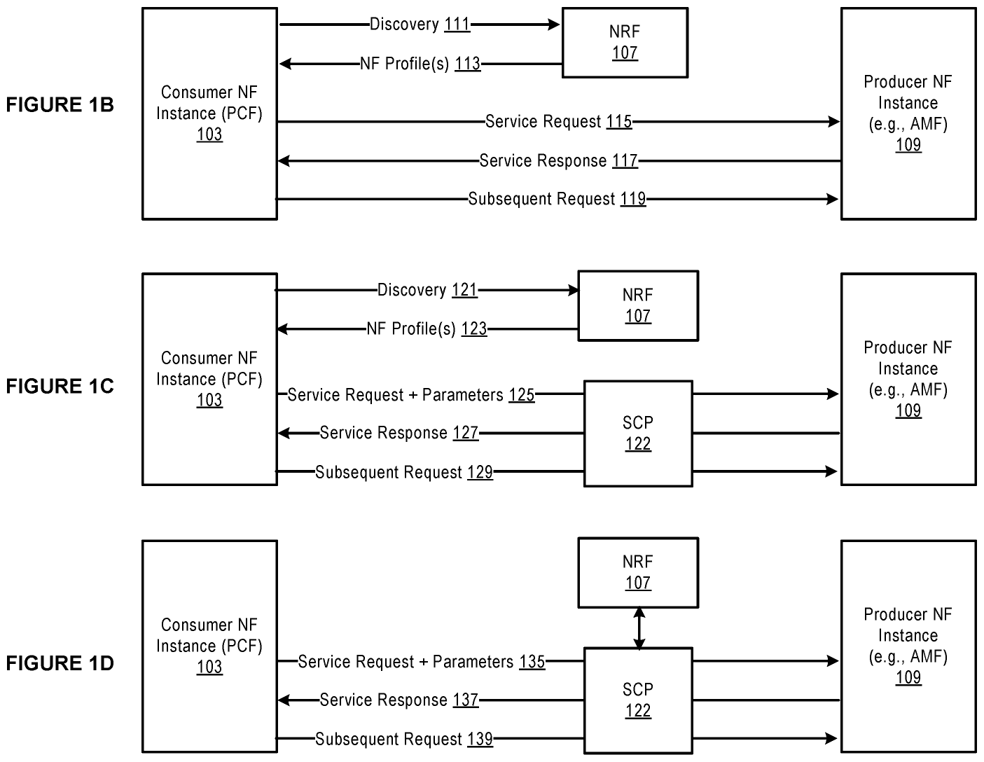

FIG. 1A is a block diagram illustrating how an NRF 107 in a 5G network architecture facilitates communication among NF instances 103 and 109 according to an embodiment of the disclosure. The NRF 107 maintains a registry of other network functions (NFs). This registry can include information such as an NF's type, location, and capabilities. The NRF 107 uses the registry to facilitate communication between NFs. Multiple instances of an NF type can be registered with the NRF 107, which maintains information about each registered NF instance to ensure load balancing, redundancy, and optimal resource utilization within the network.

In one embodiment, when an instance of an NF type (i.e., consumer NF type) needs to communicate with another NF type (i.e., producer NF type) to request services from the other NF type, an instance of the consumer NF type (e.g., a consumer NF instance 103) can send a discovery request to the NRF 107. The discovery request can include a number of parameters, with the target NF type being a mandatory parameter and the rest being optional parameters. The NRF 107, upon receiving the discovery request, can search its registry and return instances of the producer NF type that match the requirements of the discovery request to a requesting NF instance, along with contact information and capabilities for each NF instance. For example, the contact information returned by the NRF 107 can include an IP address, a fully qualified domain name (FQDN), a port number, and security information, and the capabilities of the producer NF instance can include services and protocols that the producer NF instance supports. In this figure, the producer NF instance 109 is one of the instances returned by the NRF 107 to the consumer NF instance 103.

After receiving the instances of the producer NF instances, the consumer NF instance 103 can select one of the producer NF instances (e.g., the producer NF instance 109) to establish a direct connection using the contact information of the selected producer NF instance.

However, in this embodiment of the disclosure, if the selected producer NF instance 109 malfunctions, the NRF 107 would not be able to detect that the producer NF instance has problems and would still return the instance to the consumer NF instance 103. A malfunctioning producer NF may not perform as expected and may cause problems, such as inaccurate billing and call failures.

FIGS. 1B-1D are block diagram illustrating different models for NF/NF services interactions according to an embodiment of the disclosure. These figures provide a high-level description of the different communication models that NF and NF services can use to interact with each other. Each of FIGS. 1B, 1C, and 1D illustrates one such communication model. The various embodiments described in this disclosure for preventing a malfunctioning NF instance from being discovered are applicable to all three communication models.

FIG. 1B illustrates a communication model where NRF services are used. In this model, the consumer NF instance 103 sends a discovery request 111 to query the NRF 107. Based on the discovery result, the consumer NF instance 103 selects a discovered producer NF instance (e.g., the NF producer instance 109) and then sends a service request 115 to the selected producer NF instance. The consumer NF instance 103 can then receive a service response 117 from the producer NF instance 109 and send a subsequent request 119 to the NF producer instance 109.

FIG. 1C illustrates a communication model where an SCP 122 is used. In this model, the consumer NF instance 103 sends a discovery request 121 to query the NRF 107. Based on the discovery result, the consumer NF instance 103 selects a producer NF set or a specific producer NF instance from the producer NF set. The consumer NF instance 103 then sends a service request 125 to the SCP 122 containing the address of the selected producer NF instance or the addresses of the set of selected NF producer instances. In the latter case, the SCP 122 routes the traffic between the consumer and Producer an NF

In the communication model illustrated in FIG. 1D, the consumer NF instance 103 does a delegated NF discovery through SCP 122. In an embodiment, the consumer NF instance 103 can include discovery and selection parameters 131 in a service request 135 that is sent to the SCP 122. The SCP 122 can use the discovery and selection parameters 131 to find a suitable producer NF instance (e.g., the producer NF instance 109), and route the service request 135 to that producer NF instance. Subsequent communications 137 and 139 between the consumer NF instance 103 and the producer NF instance also go through the SCP 122.

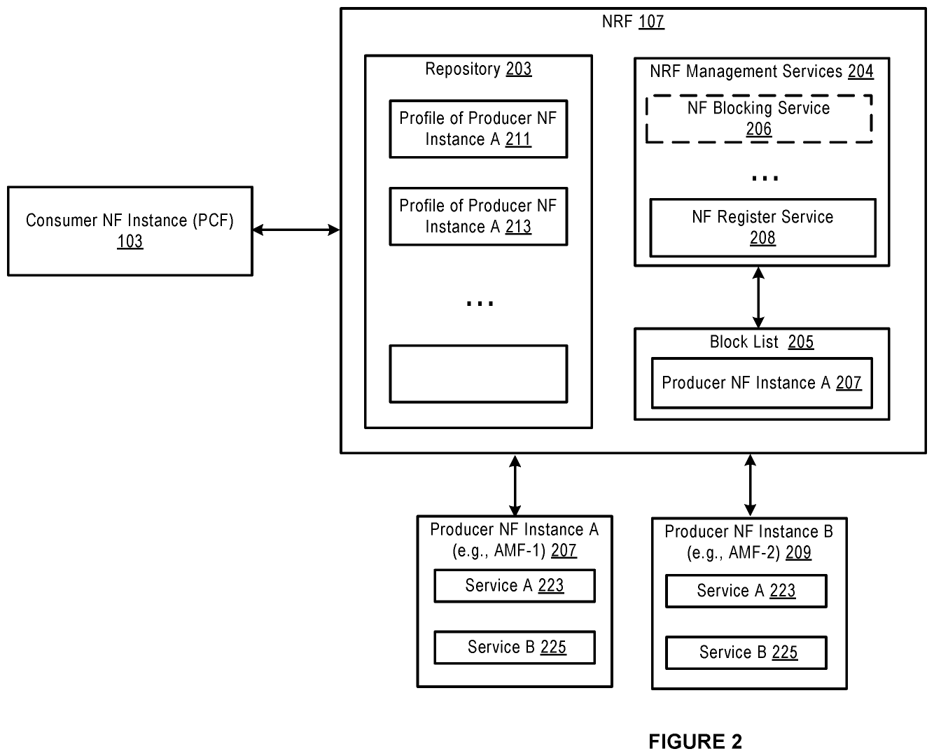

FIG. 2 is a block diagram illustrating the NRF 107 with an NF blocking service 206 that can prevent a malfunctioning NF instance from being discovered according to an embodiment of the disclosure.

As shown in FIG. 2, two producer NF instances 207 and 209 can register their profiles 211 and 213 with the NRF 107 using a NF register service 208, which is one of a plurality of management services 204 provided by the NRF 107. Each profile can include various details about the NF instance, such as information about the services it provides. These details can be stored in a repository 203 of the NRF 107 and can be used by other NF instances, applications, and network management systems to discover and interact with the registered NF instance.

As also shown, the producer NF instance A 211 is on a block list 205, indicating that the producer NF instance has been determined to be a malfunctioning instance. In this embodiment, both NF instances 207 and 209 are of the same NF type and provide the same set of services 223 and 225.

In response to a discovery request from the consumer NF instance 103 for a specific service or network function (e.g., service A 223) provided by a particular NF type, the NRF 107 can search in the repository 203 to determine which instances of the particular NF type can provide such a service/network function. For example, the NRF 107, after searching the repository 203, has determined that both producer NF instances 207 and 209 can provide the requested service/network function based on their registered profiles 211 and 213. However, before returning the two profiles 211 and 213 to the consumer NF instance 103, the NRF 107 can call the blocking service 206 to check the block list 205 to determine if any of the NF instances 207 and 209 is on the block list 205.

Since the producer NF instance A 207 is on the block list, the NRF 107 can remove the producer NF instance from a list of NF instances that meet the discovery request from the consumer NF instance 103 before returning the list to the consumer NF instance 103. Thus, the blocking service 206 can prevent the producer NF instance 207 from being returned to the consumer NF instance 103. In an embodiment, the NRF 107 can share the profile of each returned producer NF instance with the consumer NF instance 103, which can subsequently select a returned producer NF instance and can send a service request to the selected producer NF instance.

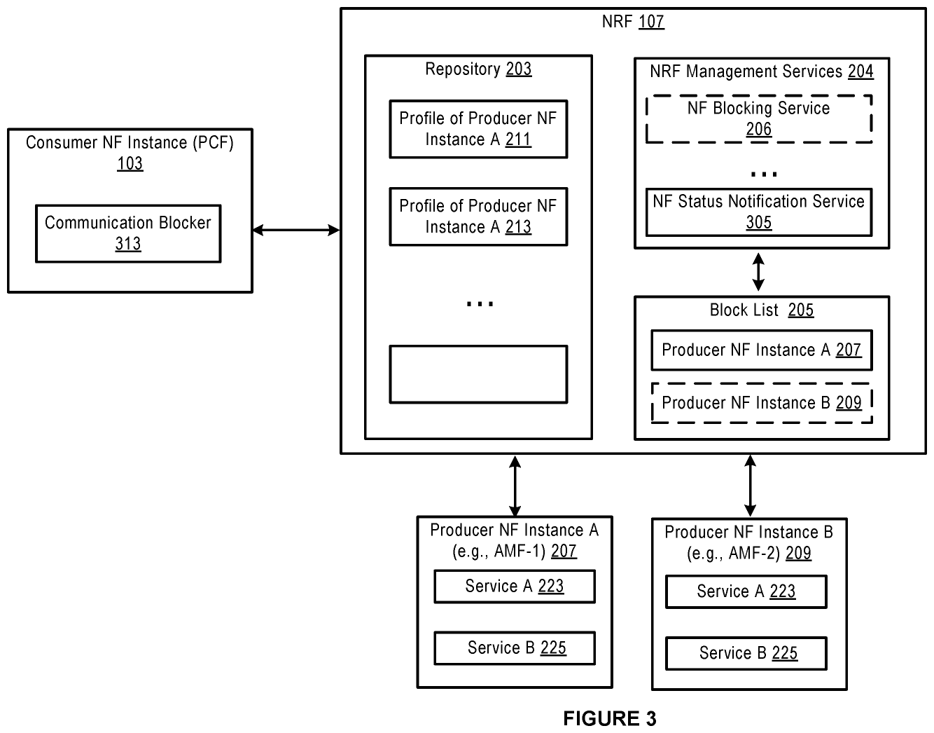

FIG. 3 is a block diagram illustrating a communication blocking function in each NF instance registered with the NRF 107 according to an embodiment of the disclosure.

As shown in FIG. 3, each NF instance in a 5G network can include a communication blocker, such as a communication blocker 313 in the consumer NF instance 103. Each communication blocker can include an API for use in blocking communication with another NF instance.

For example, if the consumer NF instance 103 is consuming the producer NF instance B 209, which is suddenly added to the block list 205 by the NRF 107 due to abnormal behaviors displayed by the producer NF instance B 209, the NRF 107 would instruct an NF status notification service 305 to notify all consumer NF instances registered with the NRF 107 of the status change of the producer NF instance B 209.

Upon receiving the notification, the consumer NF instance 103 can call the communication blocker 313 to block API calls between the consumer NF instance 103 and the producer NF instance 209 such that the consumer NF instance 103 can cease its consumption of the malfunctioning producer NF instance 209 and can start to establish a connection with another producer NF instance that is not on the block list 205. In an embodiment, the other producer NF can be one of the NF producer instances that were returned to the consumer NF instance 103 in response to the initial discovery request. This illustration depicts two producer NF instances, namely 207 and 209. For the sake of clarity in presentation, additional comparable producer NF instances are omitted.

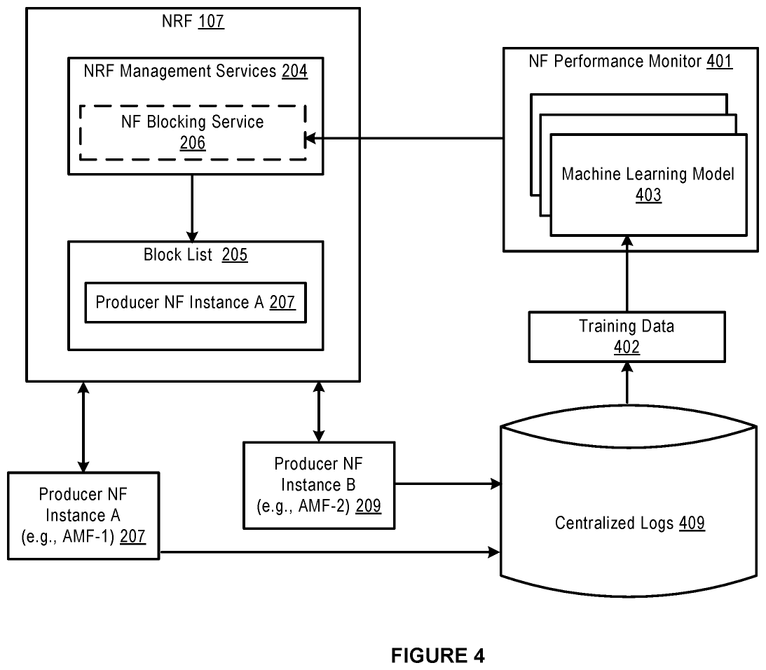

FIG. 4 is a block diagram illustrating a system for automatically detecting malfunctioning NF instances in a 5G network according to an embodiment of the disclosure.

An NF performance monitor 401 can be provided in the 5G network to automatically detect a malfunctioning NF instance through monitoring network traffic to identify unexpected behavior, such as unusual traffic patterns that might indicate a malfunction. The NF performance monitor 401 can also identify a malfunctioning NF instance through analyzing key performance indicators (KPIs) related to an NF instance, such as latency, throughput, packet loss rate, connection success rate, etc. If a predetermined number of KPIs of an NF instance are below their respective predetermined thresholds, the NF performance monitor 401 can flag the NF instance as being malfunctioning.

This embodiment use machine learning models to detect malfunctioning NF instances. In some embodiments, a machine learning model can be trained for each NF type based on historical log data, error codes and/or traffic data stored in a centralized logs database 409 of the 5G network. Different machine learning models are trained for different NF types because the NF types may have different performance characteristics.

For example, a machine learning model 403 is trained for AMF, and thus would be able to detect malfunctions in the producer NF instances 207 and 209. The machine learning model 403 can use a set of algorithms or be implemented as a deep learning model to detect anomalies in the network's operation. When the machine learning model 403 is algorithm-based, it can detect malfunctions in an NF instance by comparing current performance data of the NF stances and historical patterns of the NF instance that have been recognized as being abnormal. When it is implemented as deep learning model (e.g., a convolutional neural network), the machine learning model can be trained based on training data 402 that has been prepared from the centralized logs database 409. The training data 402 can include a dataset of network traffic data from NF instances 207 and 209 and other NF instances of the same NF types (not shown) known to be malfunctioning and from the NF instances known to be working properly. The training data 402 can be labeled such that each data point can be labeled as either “malfunctioning” or “working properly.” In some embodiments, the machine learning model 403 can receive network traffic data (e.g., the number of packets sent and received, the latency of the packets, and the error rate of the packets from each producer NF instance) as input and generate a binary value indicating whether the NF instance is malfunctioning.

After identifying a malfunctioning NF instance (e.g., the producer NF instance A 207), the NF performance monitor 401 can send a notification to the NF blocking service 206, which can call an appropriate API to add the malfunctioning NF instance to the block list 205. In some embodiments, a malfunctioning NF instance can be added to the block list 205 by adding a unique identifier of the NF instance to the block list 205.

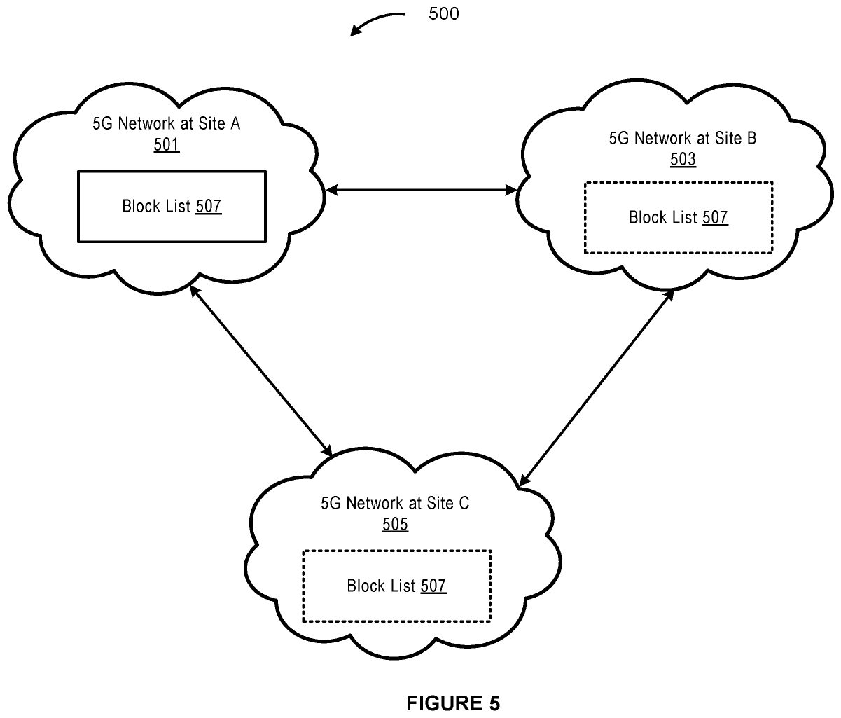

FIG. 5 illustrates an example of a multi-site 5G replication architecture 500 where a block list at any of the sites can be replicated to all other sites according to an embodiment of the disclosure. The 5G multi-site replication architecture 500 comprises three different sites 501-503 that are situated in distinct geographical locations. The sites 501-503 can include standalone 5G networks that substantially resemble one another. Thus, the multi-site replication architecture 500 can distribute traffic load across the sites and be scaled up to support more NF instances when necessary. Further, it can reduce network downtime, because if one site fails, the traffic can be routed to the NF instances of the same NF type on another site.

In one embodiment, a block list 507 created at one site (i.e., the site A 501) can be replicated to each of the other sites (i.e., the site B 503, and the site C 505) so that the NRFs from all sites are aware of malfunctioning NF instances on the block list and restrict from sharing the profile of any of the NF instances on the block list 507 with a requesting consumer NF instance.

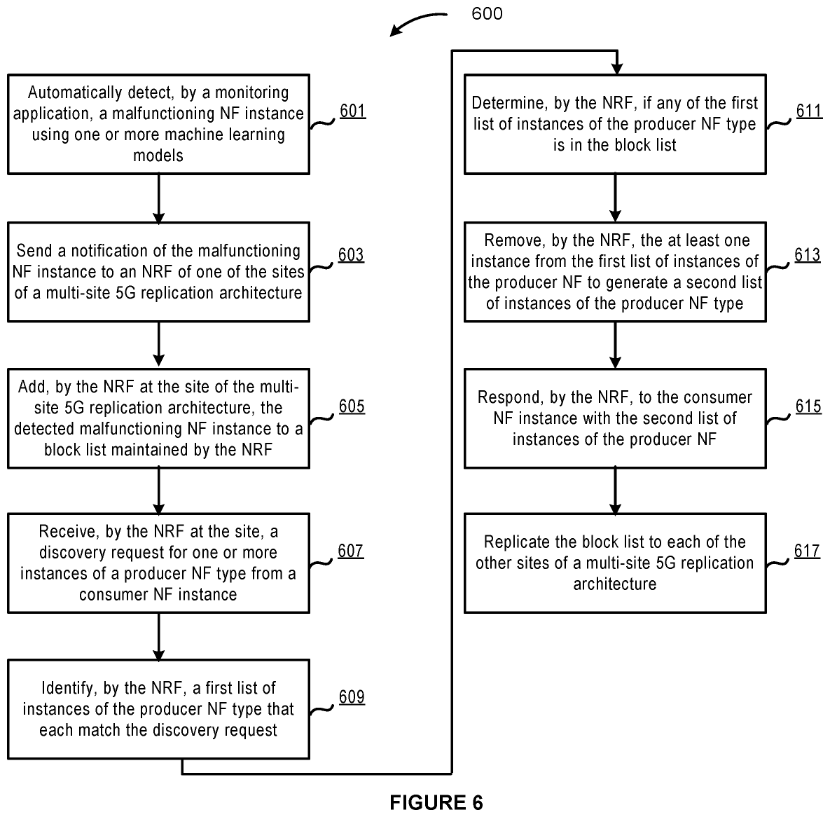

FIG. 6 is a flow diagram illustrating a process 600 of implementing a method of preventing malfunctioning producer NF instances from being discovered by consumer NF instances according to an embodiment of the disclosure.

At step 601, a monitoring application uses one or more machine learning models to detect a malfunctioning NF instance. The one or more machine learning models can be trained using historical data collected from each NF at each site of a multi-site 5G replication architecture. Although one machine learning model can be used, multiple machine learning models used in combination can increase the accuracy of malfunction detection. For example, an algorithm-based machine learning model can be used together with a deep learning model, and only when both models determine a particular NF instance is malfunctioning does the monitoring program flag the NF instance as being malfunctioning.

At step 603, the monitoring program sends a notification to a NRF of a site of a multi-site replication 5G architecture. This site can be any site or a site that hosts the monitoring program.

At step 605, the NRF, upon receiving the notification of the malfunctioning NF instance, calls one of the NRF management services (i.e., the blocking service 206 in FIGS. 2 and 3) to add the malfunctioning NF instance to a block list. In an embodiment, the blocking service can be a NRF management service that is added to the NRF and is configured to add an NF instance to a block list, remove an NF instance to the block list, and instruct the NRF to notify any consumer NF instance currently consuming any NF instance on the block list to cease its consumption.

At step 607, the NRF receives a discovery request for one or more instances of a producer NF type from a consumer NF instance. The discovery request can include a plurality of parameters, such as a registered NF type and a target NF type. The discovery request can be sent by a consumer NF instance within the same 5G network with the requested producer NF type or from another 5G network within the same country or a different country.

At step 609, the NRF identifies a first list of instances of the producer NF type that each match the discovery request based on their profiles in the repository of the NRF. The discovery request may, for example, intend to discover those NF instances of a particular type capable of providing a particular service, and/or with one or more other attributes. The first list of NF instances identified by the NRF can include NF instances that meet those criteria/parameters/requirements specified in the discovery request.

At step 611, the NRF determines if any of the first list of instances of the producer NF type is on the block list. The NRF can call the blocking service to check if any of the NF instances on the first list is also on the block list.

At step 613, if at least one NF instance on the first list is also on the block list, the NRF can call the blocking service to remove the at least one instance from the first list of NF instances to generate a second list of instances of the producer NF type.

At step 615, the NRF responds to the consumer NF instance with the second list of instances of the producer NF type. The consumer NF instance subsequently selects one of the NF instances from the second list of instances and sends a service request to the selected NF instance.

At step 617, the block list is replicated to each of the other sites of a multi-site 5G replication architecture. The replication can be performed by replication programs at the site. This step can be performed any time after the block list is created and can be performed periodically.

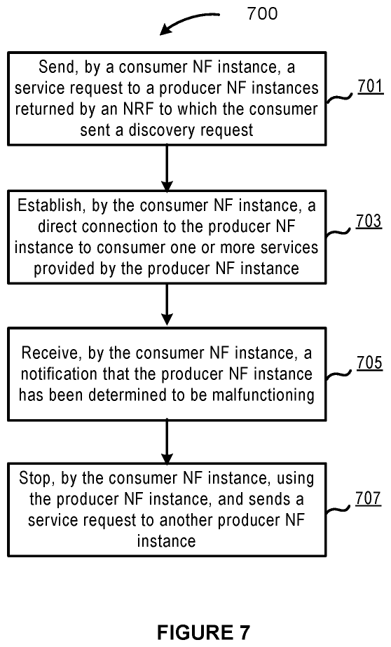

FIG. 7 is a flow diagram illustrating a process 700 showing impact of NF instance blocking on a consumer NF instance according to an embodiment of the disclosure.

At step 701, a consumer NF instance sends a service request to a producer NF instances returned by an NRF. This process can be considered a continuation of the process 600 described in FIG. 6. The selection can be based on a number of factors, such as its current load and physical location or locality.

At step 703, the consumer NF instance establishes a direct connection to the producer NF instance to consumer one or more services provided by the producer NF instance.

At step 705, the consumer NF instance receives a notification that the producer NF instance has been determined to be malfunctioning. The notification can be triggered by adding the producer NF instance to a block list. The notification can instruct the consumer NF instance to cease its consumption of the producer NF instance.

At step 707, the consumer NF instance, upon the notification, stop consuming the producer NF instance that has been added to the block list. The consumer NF instance can terminate all communications with the producer NF instance and subsequently send a service request to another producer NF instances that has similar capability with the malfunctioning producer NF instance.

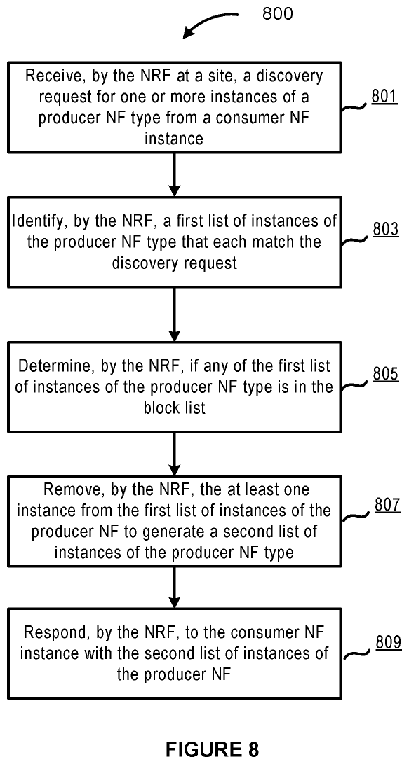

FIG. 8 is a flow diagram illustrating a process 800 of preventing a malfunctioning producer NF instance from being discovery by a consumer NF instance in a discovery request according to an embodiment of the disclosure. The process 800 can be performed by software, hardware or a combination thereof. For example, the process 800 can be performed by an NRF in a 5G network.

At step 801, the NRF receives a discovery request for one or more instances of a producer NF type from a consumer NF instance.

At step 803, the NRF identifies a first list of instances of the producer NF type that each match the discovery request.

At step 805, the NRF determines if any of the first list of instances of the producer NF type is on the block list.

At step 807, if at least one NF instance on the first list is on the block list, the NRF removes the at least one instance from the first list of NF instances of the producer NF to generate a second list of instances of the producer NF type.

At step 809, the NRF responds to the consumer NF instance with the second list of instances of the producer NF type.

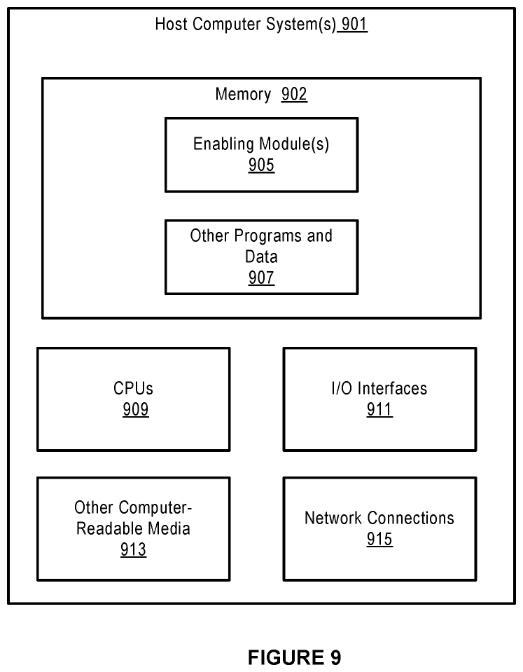

FIG. 9 shows a system diagram that describes an example implementation of a computing system(s) for implementing embodiments described herein.

The functionality described herein for blocking malfunctioning network functions from being discovered in a wireless network can be implemented either on dedicated hardware, as a software instance running on dedicated hardware, or as a virtualized function instantiated on an appropriate platform, e.g., a cloud infrastructure. In some embodiments, such functionality can be completely software-based and designed as cloud-native, meaning that they are agnostic to the underlying cloud infrastructure, allowing higher deployment agility and flexibility. However, FIG. 7 illustrates an example of underlying hardware on which such software and functionality can be hosted and/or implemented.

In this embodiment, an example host computer system(s) 901 is used to represent one or more of those in various data centers, base stations and cell sites shown and/or described herein that are, or that host or implement the functions of: routers, components, microservices, nodes, node groups, control planes, clusters, virtual machines, network functions (NFs), intelligence layers, orchestrators and/or other aspects described herein, as applicable, for blocking malfunctioning producer NF instances from being discovered by consumer NF instances in discovery requests. In some embodiments, one or more special-purpose computing systems can be used to implement the functionality described herein. Accordingly, various embodiments described herein can be implemented in software, hardware, firmware, or in some combination thereof. Host computer system(s) 901 can include memory 902, one or more central processing units (CPUs) 909, I/O interfaces 911, other computer-readable media 913, and network connections 915.

Memory 902 can include one or more various types of non-volatile (non-transitory) and/or volatile (transitory) storage technologies. Examples of memory 902 can include, but are not limited to, flash memory, hard disk drives, optical drives, solid-state drives, various types of random-access memory (RAM), various types of read-only memory (ROM), neural networks, other computer-readable storage media (also referred to as processor-readable storage media), or the like, or any combination thereof. Memory 902 can be utilized to store information, including computer-readable instructions that are utilized by CPU 909 to perform actions, including those of embodiments described herein.

Memory 902 can have stored thereon enabling module(s) 905 that can be configured to implement and/or perform some or all of the functions of the systems, components and modules described. Memory 902 can also store other programs and data 907, which can include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, intelligence layer software, network functions (NF), artificial intelligence (AI) or machine learning (ML) programs or models to perform the functionality described herein, user interfaces, operating systems, other network management functions, other NFs, etc.

Network connections 915 are configured to communicate with other computing devices to facilitate the functionality described herein. In various embodiments, the network connections 915 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 911 can include video interfaces, other data input or output interfaces, or the like. Other computer-readable media 913 can include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

What is claimed is:

1. A method of blocking malfunctioning network function (NF) instances in a wireless network, comprising:
receiving, at a network repository function (NRF) in the wireless network, a discovery request for one or more instances of a producer NF type from a consumer NF instance, wherein the NRF has a plurality of instances of the producer NF type registered with the NRF, wherein at least one instance of the plurality of instances of the producer NF type is on a block list, wherein the block list includes one or more NF instances that have been determined to be malfunctioning;
identifying, by the NRF, a first list of instances of the producer NF type that each match the discovery request;
determining, by the NRF, if any of the first list of instances of the producer NF type is on the block list;
in response to determining that at least one instance of the first list of instances of the producer NF type is on the block list, removing, by the NRF, the at least one instance from the first list of instances of the producer NF to generate a second list of instances of the producer NF type; and
responding, by the NRF, to the consumer NF instance with the second list of instances of the producer NF.

2. The method of claim 1, wherein the generating the second list of instances of the NF producer type are performed by a service in the NRF.

3. The method of claim 1, wherein the at least one instance of the target producer type is determined to be malfunctioning by a monitoring program based on a trained machine learning model.

4. The method of claim 3, wherein the monitoring program is configured to automatically add a malfunctioning NF instance to the block list by calling an application programming interface (API) of a service configured to manage the block list.

5. The method of claim 4, wherein the NRF is configured to send a notification to the consumer NF instance that is consuming one or more services provided by the malfunctioning NF instance that has been added to the block list.

6. The method of claim 5, wherein the consumer NF instance is configured to stop using the malfunctioning NF instance upon receiving the notification.

7. The method of claim 1, wherein the wireless network is a fifth generation (5G) network, which is hosted on one of a plurality of sites of a multi-site replication architecture, wherein a block list is created on any one of the plurality of sites is automatically replicated to the rest of the sites.

8. A non-transitory computer-readable storage medium having computer-executable instructions stored thereon for blocking malfunctioning network function (NF) instances in a wireless network, wherein the computer-executable instructions, when executed by one or more processors of the wireless network, cause a network repository function (NRF) in the wireless network to perform operations comprising:
receiving a discovery request for one or more instances of a producer NF type from a consumer NF instance, wherein the NRF have a plurality of instances of the producer NF type registered with the NRF, wherein at least one instance of the plurality of instances of the producer NF type is on a block list, wherein the block list includes one or more NF instances that have been determined to be malfunctioning;
identifying a first list of instances of the producer NF type that each match the discovery request;
determining if any of the first list of instances of the producer NF type is on the block list;
in response to determining that at least one instance of the first list of instances of the producer NF type is on the block list, removing the at least one instance from the first list of instances of the producer NF to generate a second list of instances of the producer NF type; and
responding to the consumer NF instance with the second list of instances of the producer NF.

9. The non-transitory computer-readable storage medium of claim 8, wherein the generating the second list of instances of the NF producer type are performed by a service in the NRF.

10. The non-transitory computer-readable storage medium of claim 8, wherein the at least one instance of the target producer type is determined to be malfunctioning by a monitoring program based on a trained machine learning model.

11. The non-transitory computer-readable storage medium of claim 10, wherein the monitoring program is configured to automatically add a malfunctioning NF instance to the block list by calling an application programming interface (API) of a service configured to manage the block list.

12. The non-transitory computer-readable storage medium of claim 11, wherein the NRF is configured to send a notification to the consumer NF instance that is consuming one or more services provided by the malfunctioning NF instance that has been added to the block list.

13. The non-transitory computer-readable storage medium of claim 12, wherein the consumer NF instance is configured to stop using the malfunctioning NF instance upon receiving the notification.

14. The non-transitory computer-readable storage medium of claim 8, wherein the wireless network is a fifth generation (5G) network, which is hosted on one of a plurality of sites of a multi-site replication architecture, wherein a block list is created on any one of the plurality of sites is automatically replicated to the rest of the sites.

15. A system for blocking malfunctioning network function (NF) instances in a wireless network, comprising:
one or more processors; and
one or more memories a memory coupled to the one or more processors and storing computer-executable instructions, which, when executed by the one or more processors, cause a network repository function (NRF) in the wireless network to perform operations comprising:
receiving a discovery request for one or more instances of a producer NF type from a consumer NF instance, wherein the NRF have a plurality of instances of the producer NF type registered with the NRF, wherein at least one instance of the plurality of instances of the producer NF type is on a block list, wherein the block list includes one or more NF instances that have been determined to be malfunctioning;
identifying a first list of instances of the producer NF type that each match the discovery request;
determining if any of the first list of instances of the producer NF type is on the block list;
in response to determining that at least one instance of the first list of instances of the producer NF type is on the block list, removing the at least one instance from the first list of instances of the producer NF to generate a second list of instances of the producer NF type; and
responding to the consumer NF instance with the second list of instances of the producer NF.

16. The system of claim 15, wherein the generating the second list of instances of the NF producer type are performed by a service in the NRF.

17. The system of claim 15, wherein the at least one instance of the target producer type is determined to be malfunctioning by a monitoring program based on a trained machine learning model.

18. The system of claim 17, wherein the monitoring program is configured to automatically add a malfunctioning NF instance to the block list by calling an application programming interface (API) of a service configured to manage the block list.

19. The system of claim 18, wherein the NRF is configured to send a notification to the consumer NF instance that is consuming one or more services provided by the malfunctioning NF instance that has been added to the block list.

20. The system of claim 19, wherein the consumer NF instance is configured to stop using the malfunctioning NF instance upon receiving the notification.
